(19) United States
(12) Patent Application Publication
(10) Pub. No.: US 2026/0272165 A1
(43) Pub. Date: Sep. 17, 2026

(54) Telescopic System and Preloading Element

(71) Applicant: igus SE & Co. KG, Köln (DE)

(72) Inventors: Muhammet Erkam Türker, Nörvenich (DE); Stefan Niermann, Paderborn (DE); Marco Jaekel, Langenfeld (DE)

(21) Appl. No.: 19/474,448

(22) PCT Filed: Apr. 11, 2024
(86) PCT No.: PCT/EP2024/059787

§ 371 Date: Oct. 10, 2025

(30) Foreign Application Priority Data
Apr. 13, 2023 (DE) 20 2023 101 873.4

(51) Int. Cl. A47B 88/483

(52) U.S. Cl. CPC A47B 88/483

(57) ABSTRACT

A telescopic system (1) includes rail elements (2, 3, 4), which are displaceable with respect to one another in the longitudinal direction. At least one rail element includes a lower outer rail (5) and at least one rail element includes an upper outer rail (6), with the proviso that at least one further rail element includes a middle rail (7), which is located between the lower outer rail and the upper outer rail. All the rail elements have sliding surfaces. At least the middle rail has a core element (15) and a sheath material (16) with the sheath material forming the sliding surfaces of the middle rail at least in regions.

The invention relates to a telescopic system with rail elements, which are displaceable relative to one another in the longitudinal direction, at least one rail element forming a lower outer rail and at least one rail element forming an upper outer rail, with the proviso that at least one further rail element forms a middle rail arranged between the lower outer rail and the upper outer rail, all the rail elements having sliding surfaces. It additionally relates to a preloading element.

A telescopic system of this type may, for example, be put to use for a displacement apparatus, for displaceably installing industrial plant. One example of another application is a storage device which needs to be displaceably arranged, e.g., a drawer.

A telescopic system of the above type is described in DE 20 2005 005 760 U1 . The aim of the known telescopic system is to achieve a construction with low maintenance requirements. The solution proposed in this publication is itself based on an even older telescopic system which is criticized in DE 20 2005 005 760 U1 as being relatively heavy.

The solution in the form of the telescopic system of DE 20 2005 005 760 U1 comprises a middle rail made of plastics material and therefore of lower weight. This known telescopic system has disadvantages regarding load rating and load-carrying capacity. Its unsatisfactory load rating and load-carrying capacity can be attributed at least in part to the selection of plastics as the material for the middle rail.

The object of the present invention is to propose a telescopic system which retains a simple structure and low maintenance requirements while additionally exhibiting an enhanced load rating and load-carrying capacity.

According to the invention, this object is achieved in that at least the middle rail has a core element and a cladding material, and in that the cladding material at least in places forms the sliding surfaces of the middle rail.

The proposed structure allows selection of the cladding material to be made according to the criterion of good sliding properties. In particular, the sliding properties of the cladding material may be selected taking into account of the material of the outer rails, because the middle rail forms a sliding pair with each of the outer rails. The proposed measure makes it possible to provide an appropriate material pairing for the corresponding combination of middle rail/outer rail for the purpose of providing good sliding properties.

Furthermore, a suitable configuration and/or a suitable material for the core element can be selected irrespective of the cladding material. The configuration of the core element is in particular independent of the sliding properties contributed by the cladding material. In this way, the core element can be configured with a higher load rating and load-carrying capacity, in particular a greater bending strength and greater torsional strength.

At least one of the rail elements conveniently comprises aluminum, or an aluminum alloy, it preferably being the middle rail that comprises the aluminum alloy. The core element of the middle rail may, in particular, be made from this metal or from this alloy. In principle, another metal can also be provided instead of an aluminum alloy, e.g., steel. The aluminum alloy or, in more general terms, aluminum has favorable strength properties. The modulus of elasticity and dimensional rigidity thereof are very well suited to constructing a middle rail which can provide the telescopic system with a good load rating and load-carrying capacity.

In said prior art document DE 20 2005 005 760 U1 , the middle rail consists of plastics material. Plastics material is a lower strength material than a metal, such as steel or aluminum. The modulus of elasticity of the plastics material is lower than that of the stated metals. Plastics material likewise exhibits lower dimensional rigidity. Making the core element of the middle rail from an aluminum alloy or another metal which has a higher strength and/or higher modulus of elasticity than plastics material increases the load rating and load-carrying capacity of the telescopic system. An aluminum alloy means an aluminum material which predominantly contains aluminum and, in more general terms, is known as aluminum.

The cladding material may be applied to the core element as a coating of a sliding material. Preferably, a coating of a sliding plastics material is provided.

The coating is conveniently produced as a powder coating.

The sliding material may be a sliding plastics material, or plain bearing plastics material, of the type belonging to the class of tribologically optimized sliding plastics materials. Such an optimized material promotes lubricant-free operation or improves any dry running characteristics.

A proven sliding material is a polymeric plastics material which is tribologically optimized, i.e., has good friction and/or lubrication characteristics accompanied by low wear to the surface of the sliding material. Such a polymeric plastics material is known as a tribopolymer. A sliding material of this type may conveniently be processed as a powder, i.e., be applied to the core element of the middle rail as a powder coating using a suitable powder coating method.

The tribopolymer may be a thermoplastic tribopolymer, such as polyethylene (PE), polypropylene (PP), polyacetal (POM), polycarbonate (PC), polyamide (PA, PA6, PA12, PA46, PA66), polyvinyl chloride (PVC) and polytetrafluoroethylene (PTFE), polyketone (PK), or acrylonitrile-butadiene-styrene (ABS). The tribopolymer may moreover be thermosetting tribopolymer, e.g., phenolic resin. If good resistance to high temperatures is needed, then further base polymers can be used for the sliding material, such as polyether ketone (PEK), polyetherether ketone (PEEK), polysulfone (PSU), polyphenylsulfone (PPSU), or polyphenylene sulfide (PPS).

To reduce friction, the sliding material, such as the tribopolymer, may contain a lubricant. A possible lubricant is a finely divided solid lubricant, such as molybdenum disulfide or graphite. The sliding material may additionally contain at least one filler. The filler may be finely divided and irregularly fibrous in form or it may be fibrous and oriented in a preferred direction or it may be added as a textile fabric. Moreover, the filler may consist of plastics material. The aim of these optional measures is to improve the mechanical properties of the sliding material.

The sliding material tribologically optimized in this way, such as the tribopolymer, is preferably a “compound”, which preferably contains a base polymer, for example a thermoplastic, in particular polyamide (PA), e.g., PA6, PA12, PA46, PA66, polyacetal/polyoxymethylene (POM), polyethylene (PE), polypropylene (PP), polycarbonate (PC), polyvinyl chloride (PVC) or polytetrafluoroethylene (PTFE), acrylonitrile-butadiene-styrene (ABS), polyketone (PK), thermoplastic polyurethane (TPU), or thermoplastic elastomer (TPE).

Furthermore, the compound preferably contains particles which act as a solid lubricant, for example molybdenum disulfide and/or graphite. Furthermore, the compound preferably contains one or more fillers, for example reinforcing fibers and/or reinforcing particles.

The coating of cladding material arranged on the core element of the middle rail conveniently has a layer thickness in the range from 50 μm to 500 μm (275 μm±225 μm), preferably in the range from 50 μm to 150 μm (100 μm±50 μm). Said layer thickness is particularly preferably in the range from 50 μm to 100 μm (75 μm±25 μm). A simple solution is for the entire surface of the core element of the middle rail to be provided with said coating. Alternatively, provision may be made for just specific regions of said surface to be provided with the coating. For example, surface regions of the core element can be left uncovered by a coating if they do not come into contact with one of the outer rails during operation and therefore to not have to function at all as a sliding surface.

It has proven advantageous for at least one of the outer rails to be made from an aluminum alloy and for an anodized aluminum layer preferably to be provided on the surface thereof. The aluminum alloy or, in more general terms, aluminum has favorable strength properties. The modulus of elasticity and dimensional rigidity thereof are very well suited to constructing an outer rail which can provide a telescopic system with a good load rating and load-carrying capacity.

It is furthermore beneficial for the lower outer rail to have at least one lower guide groove and for the middle rail to have at least one associated complementary lower sliding bar. Two sliding bars are conveniently provided, these advantageously being arranged symmetrically. In one favorable embodiment, the two sliding bars point distally outward when viewed in cross-section.

The upper outer rail may correspondingly have at least one upper guide groove and the middle rail at least one associated complementary upper sliding bar. Here too, two sliding bars can be provided which are advantageously arranged symmetrically and, in one favorable embodiment, arranged pointing distally outward when viewed in cross-section.

It is also beneficial for the lower outer rail and/or the upper outer rail to be provided with a C-shaped basic cross-section, with the C-shaped basic cross-section having a plate-shaped base flange, and with side bars arranged orthogonally to the base flange being provided on opposing longitudinal sides of the base flange. The C-shaped cross-sectional configuration makes it possible to arrange the C-shaped basic cross-section of the lower outer rail and the C-shaped basic cross-section of the upper outer rail with the base flanges facing outward and their open sides facing one another. This results in an interspace between the lower outer rail and the upper outer rail, or rather between the lower base flange and the upper base flange. The interspace may be used to arrange the middle rail, which is received in protected manner therein.

It is also beneficial for the C-shaped basic cross-section of the respective outer rail to be supplemented on at least one of the side bars with a proximally arranged guide bar, such that a guide groove is formed between the guide bar and the base flange. Preferably, both side bars are supplemented in each case with a proximally arranged guide bar, so forming two guide grooves. Advantageously, the two guide grooves are arranged symmetrically and, in one favorable configuration, proximally and pointing outward when viewed in cross-section.

The two symmetrically and proximally arranged guide grooves of the respective outer rail serve in mounting sliding bars of the middle rail, which sliding bars are likewise arranged symmetrically and correspondingly distally, as described above.

It is furthermore advantageous for at least one guide rib to be arranged in the longitudinal direction of the upper outer rail and/or in the longitudinal direction of the lower outer rail on the respective base flange thereof. Two guide ribs are preferably arranged in pairs and parallel to one another.

The guide ribs of the base flange arranged in parallel and in pairs conveniently forming distally arranged lateral guide surfaces.

It is furthermore helpful for a receiving groove to be formed between the parallel guide ribs of the base flange.

It has proven particularly useful for at least one preloading element to be arranged non-displaceably on the lower outer rail and/or on the upper outer rail. The preloading element proposed here is also considered to be inventive subject matter when taken alone. In the assembled state, the preloading element is in contact with the middle rail, its purpose being to keep centered the sliding guidance provided between sliding surfaces of the respective outer rail and sliding surfaces of the middle rail. In the assembled state, preloading is inherent to the preloading element. The centering is conveniently provided by the inherent preloading of the preloading element.

The preloading element improves sliding guidance. Another essential effect of the preloading element consists in significant noise reduction. Displacement of the participating rail elements of the telescopic system is considerably quieter if the preloading element is applied. The noise-reducing effect is particularly good if two participating rail elements are associated with two preloading elements and if the latter are arranged at a given distance from one another.

The preloading element proposed can in itself have a fastening block and a centering head. The fastening block interacts advantageously with the respective outer rail to connect the preloading element with the outer rail or to mount it thereon. The centering head advantageously interacts with the middle rail to center the latter relative to the outer rail.

A retaining element is preferably used to arrange the fastening block of the above-mentioned preloading element non-displaceably in the receiving groove of the lower outer rail or non-displaceably in the upper outer rail. The retaining element can simply be configured as a retaining projection, a retaining opening being provided complementarily thereto in the receiving groove of the respective outer rail, the retaining element being insertable by press-fit into the retaining groove, for example, so resulting in a press-fit connection. Alternatively, instead of as a press-fit connection, the retaining element and the complementary receiving groove can also be configured as a form-fit connection.

A further improvement is obtained if the centering head of the above-stated preloading element projects, in the assembled state, beyond the free ends of the parallel guide ribs of the respective outer rail, wherein spring elements with sliding surfaces (spring element sliding surfaces) are arranged opposite one another on the projecting part of the centering head, and wherein, in the assembled state, the spring elements jut out with their sliding surfaces toward the side bars of the respective outer rail. The spring element sliding surfaces may then interact with associated guide surfaces of the respective outer rail, as described further below. When the spring elements are in the neutral state, the distance between their sliding surfaces is greater than the distance between the lateral guide surfaces provided proximally on the parallel guide ribs of the respective outer rail.

The mutually facing spring elements are simply configured in the manner of a leaf spring. At least one of the two ends of the leaf spring is connected with the centering head, preferably in one piece with the centering head, or is produced in one piece with the centering head; at least this one end of the leaf spring is rooted in one piece on the centering head.

The middle rail can furthermore comprise the pairwise arranged lower sliding bars, which are arranged distally, such that, in the assembled state, they point in the direction of the side bars of the lower outer rail, wherein the middle rail advantageously also comprises the pairwise arranged upper sliding bars, which are arranged distally, such that, in the assembled state, they point in the direction of the side bars of the upper outer rail.

The middle rail is conveniently provided between the lower pair of sliding bars with a lower guide channel, the cross-section of the lower guide channel having an opening which, in the assembled state, is directed toward the base flange of the lower outer rail, and the middle rail conveniently being provided between the upper pair of sliding bars with an upper guide channel, the cross-section of the upper guide channel having an opening which, in the assembled state, is directed toward the base flange of the upper outer rail.

The lower guide channel and the upper guide channel of the middle rail are provided with internal guide surfaces facing one another in pairs and, in the assembled state, the respective internal guide surfaces interact respectively with the lower outer rail or with the upper outer rail, namely with the lateral guide surfaces of the parallel guide ribs which the base flange of the lower outer rail or the base flange of the upper outer rail respectively comprises. On the other hand, in the assembled state, the respective internal guide surfaces interact with the assembled preloading element, namely with the mutually facing sliding surfaces of the centering head of the respective preloading element.

The preloading element is advantageously made from a plastics material, preferably a sliding plastics material. The (sliding) plastics material may be a single-grade plastics material. Alternatively, it may be a “compound” containing a base plastics material provided with particles which may act as a solid lubricant, such as molybdenum disulfide and/or graphite. Furthermore, the compound may contain filler, for example reinforcing fibers and/or reinforcing particles.

The lower outer rail and the upper outer rail may each be provided with a stop groove element, wherein the middle rail comprises a lower stop bar which, in the assembled state, projects into the stop groove element of the lower outer rail, and comprises an upper stop bar which, in the assembled state, projects into the stop groove element of the upper outer rail.

The stop groove element of the lower outer rail and the stop groove element of the upper outer rail are conveniently in each case provided at one end with an end stop element.

The end stop element may take the form of a set screw screwed into the respective stop groove element.

Advantageously, the lower stop bar is recessed in the longitudinal direction from the end of the middle rail over a portion of the length of the middle rail and forms a lower stop edge, wherein the upper stop bar is likewise recessed in the longitudinal direction from the other end of the middle rail over a portion of the length of the middle rail and forms an upper stop edge.

Also as part of the invention or as an independent or second invention, a telescopic system is considered which is designed on the basis of the combination of features as defined in the preamble of claim 1 such that at least one preloading element is arranged non-displaceably on the lower outer rail and/or on the upper outer rail.

For this independent invention, the preloading element may conveniently have a fastening block and a centering head.

Furthermore, it is useful for a retaining element to be used to arrange the fastening block non-displaceably in the receiving groove of the lower outer rail or upper outer rail. The retaining element can simply be configured as a retaining projection, a retaining opening being provided complementarily thereto in the receiving groove of the respective outer rail, the retaining element being insertable by press-fit into the retaining groove, for example, so resulting in a press-fit connection. Alternatively, instead of as a press-fit connection, the retaining element and the complementary receiving groove can also be configured as a form-fit connection.

It is also useful if the centering head of the above-stated preloading element projects, in the assembled state, beyond the free ends of the parallel guide ribs of the respective outer rail, wherein spring elements with sliding surfaces (spring element sliding surfaces) are arranged opposite one another on the projecting part of the centering head, and wherein, in the assembled state, the spring elements jut out with their sliding surfaces toward the side bars of the respective outer rail.

The spring element sliding surfaces may then interact with associated guide surfaces of the respective outer rail, as described above. When the spring elements are in the neutral state, the distance between their sliding surfaces is greater than the distance between the lateral guide surfaces provided proximally on the parallel guide ribs of the respective outer rail.

For both the first embodiment and the second invention, the middle rail may simply have an H-shaped cross-section which has parallel side elements and a central bar connecting these. This shape produces an open upper side embodying the upper guide channel and, on the lower side, produces the lower guide channel of the middle rail. The parallel side elements of the H-shaped cross-section are adjoined at the ends of the parallel side elements in each case by a sliding bar of the middle rail. The sliding bars are arranged distally and thus parallel to the stated central bar.

Each of the mutually facing internal guide surfaces of the guide channels of the H-shaped cross-section respectively has a size, in particular a height, such that a part of the guide surface forms a sliding strip which is in sliding contact with the parallel guide ribs of the respective outer rail, or rather the lateral guide surfaces thereof, while another part forms a sliding strip which is in sliding contact with a spring element sliding surface of the preloading element. The sliding strips of each guide surface are arranged in the direction of displacement, i.e., adjacent one another. To this end, each guide channel is embodied with a depth greater than the height of the guide ribs of the outer rails. This configuration ensures that there is space beyond the guide ribs for arranging the centering head of the preloading element in such a way that it can project beyond the guide ribs. In this way, the spring element sliding surfaces can likewise come into contact with the internal guide surfaces of the guide channels. The internal guide surfaces of the guide channels are thus sufficiently large to be able to come into contact both with the lateral guide surfaces of the guide ribs and with the spring element sliding surfaces.

As already mentioned above, the described preloading element in itself constitutes a subject matter of the invention.

The invention is illustrated below by way of example in drawings and described in detail with reference to several figures, in which:

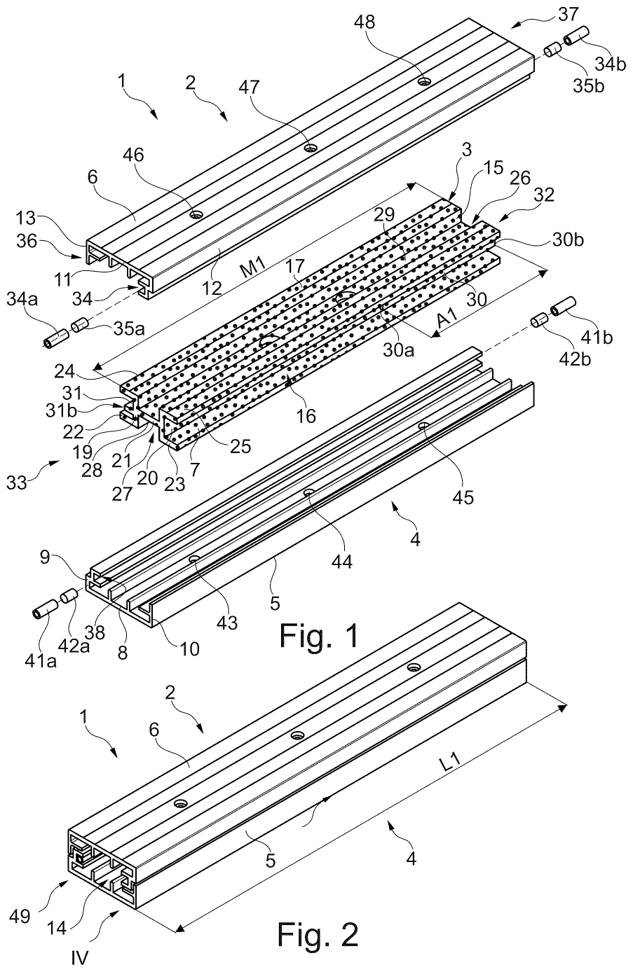

FIG. 1 is an exploded representation of component parts of a first exemplary embodiment of the telescopic system according to the invention,

FIG. 2 shows a first exemplary embodiment of the telescopic system according to the invention comprising the component parts according to FIG. 1,

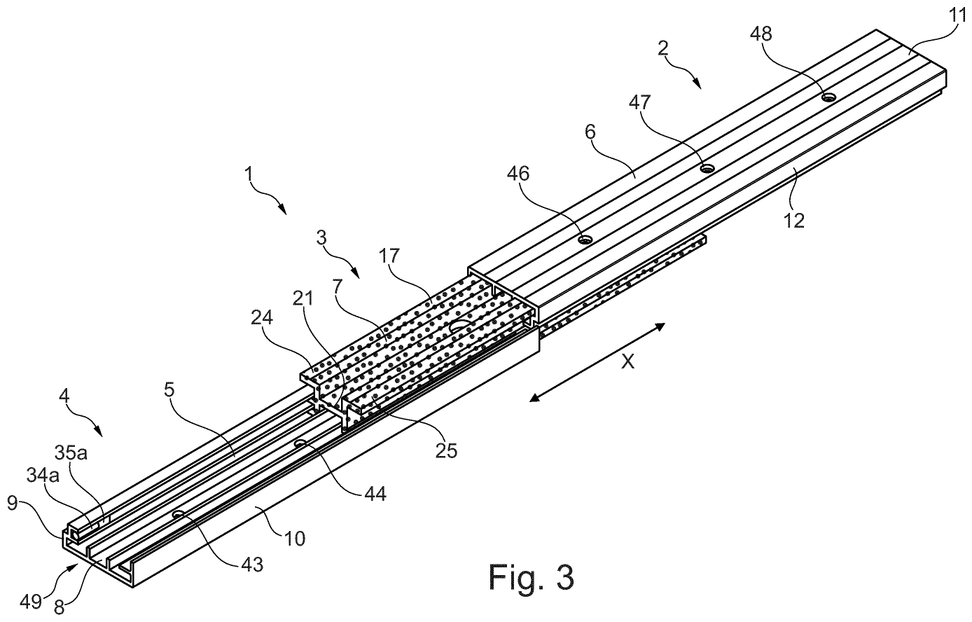

FIG. 3 shows the telescopic system according to FIG. 2 in the extended state,

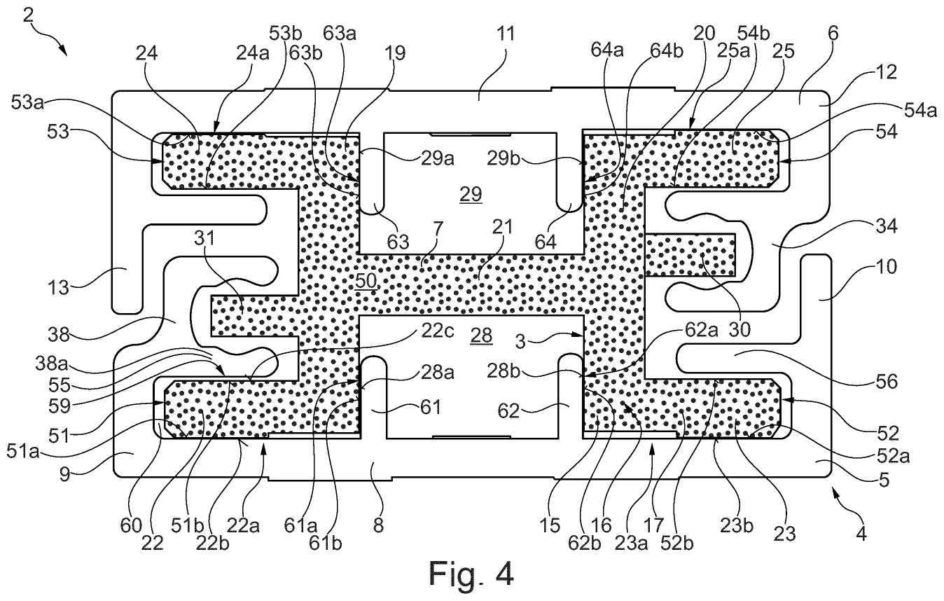

FIG. 4 is a view onto an end face of the telescopic system in the direction IV indicated in FIG. 2,

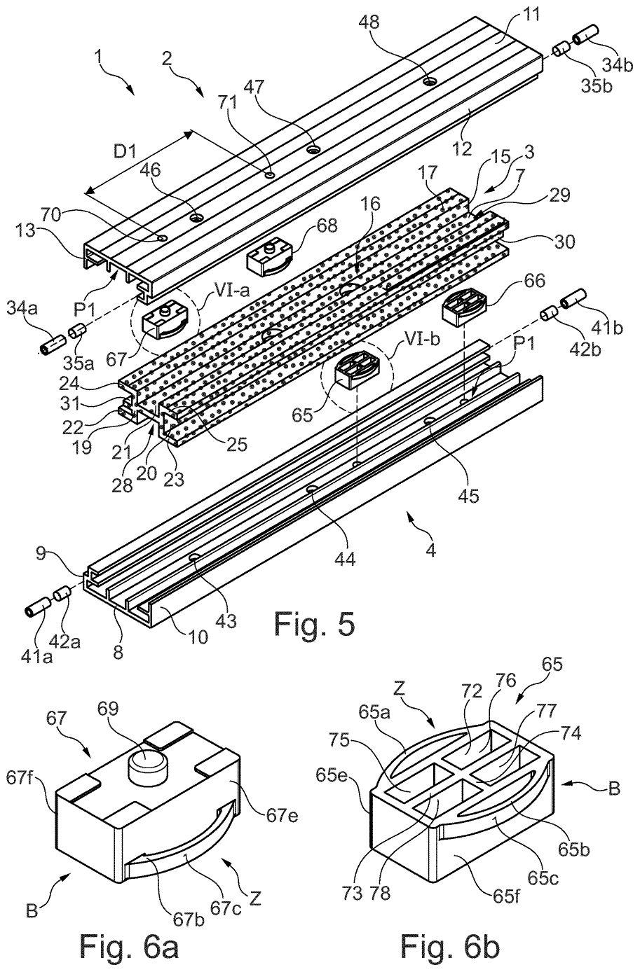

FIG. 5 is an exploded representation of component parts of a second exemplary embodiment of the telescopic system according to the invention,

FIG. 6a is a perspective representation of a preloading element according to VI-a, as indicated in FIG. 5,

FIG. 6b is a perspective representation of a preloading element according to VI-b, as indicated in FIG. 5,

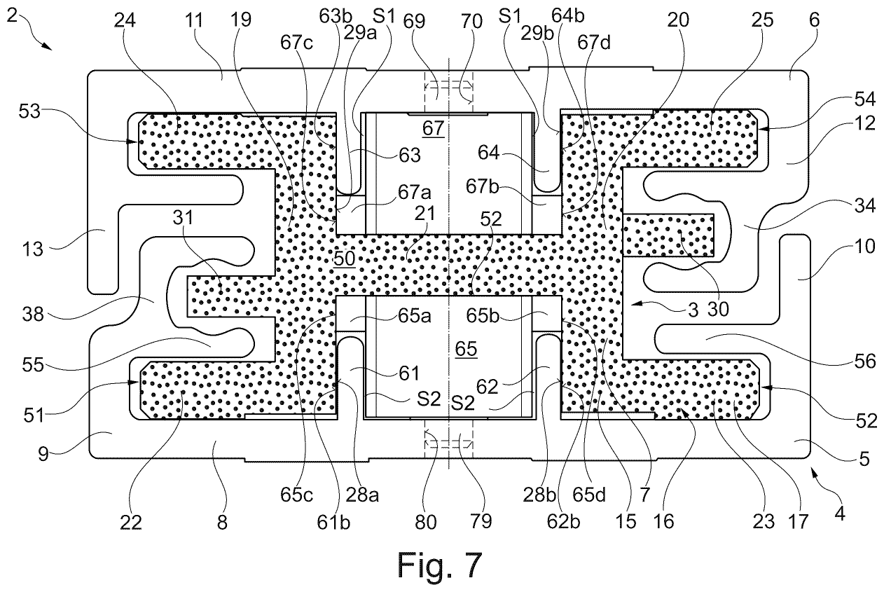

FIG. 7 shows a view onto an end face of the second exemplary embodiment of the telescopic system,

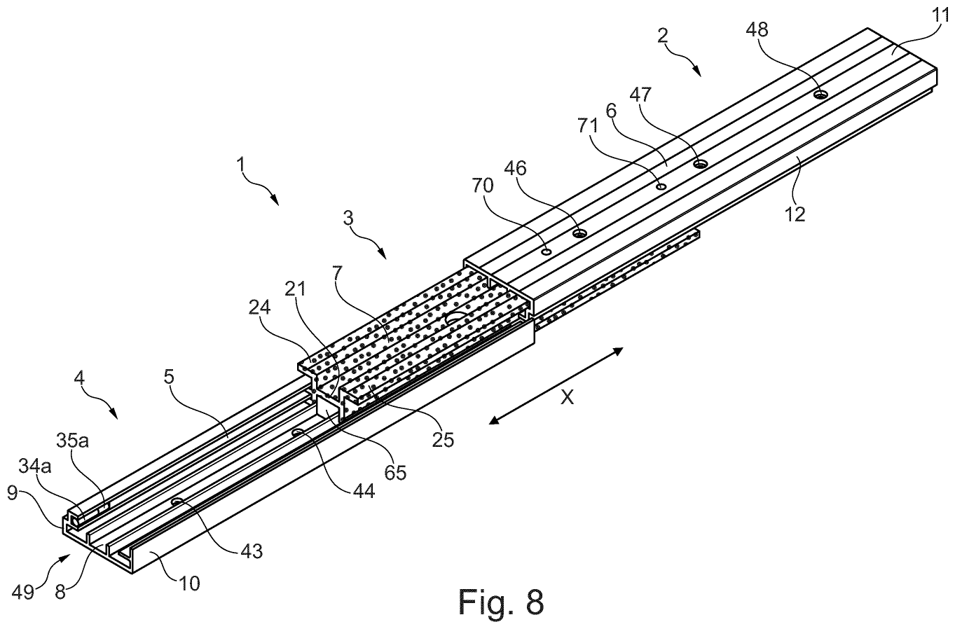

FIG. 8 shows the telescopic system according to FIG. 5 assembled and in the extended state,

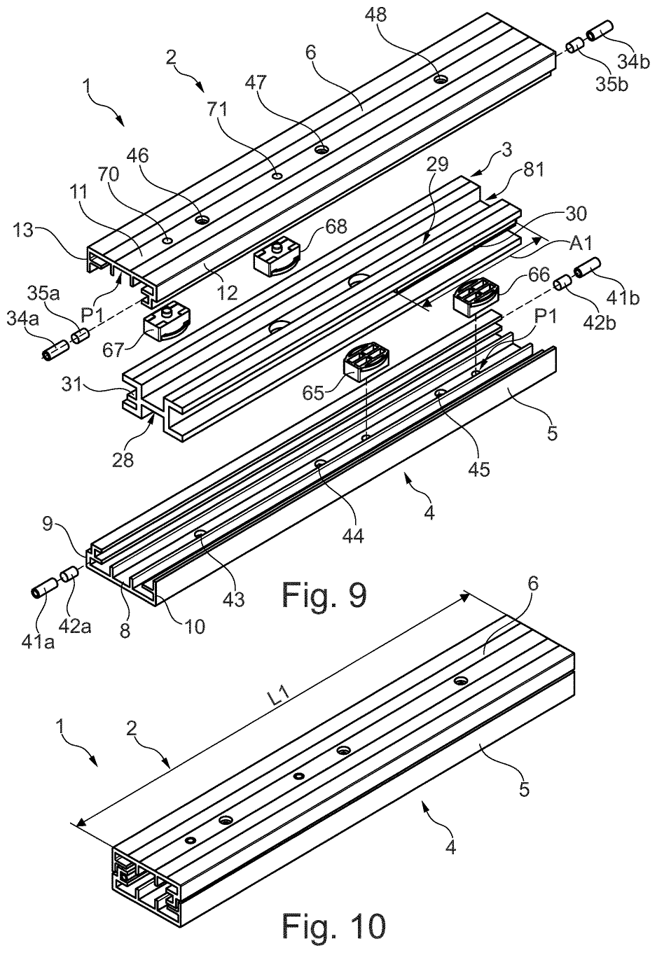

FIG. 9 is an exploded representation of component parts of a third exemplary embodiment of the telescopic system according to the invention,

FIG. 10 shows the telescopic system according to FIG. 9 assembled and with rail elements collapsed into one another.

FIG. 1 shows a perspective representation of the component parts of a first exemplary embodiment of the telescopic system 1 according to the invention. This system comprises three rail elements (2, 3, 4) represented one above the other in the form of an exploded drawing. In the assembled state, the rail elements are displaceable relative to one another in a longitudinal direction X. The rail elements comprise a lower outer rail 5 and an upper outer rail 6, and a middle rail 7 depicted between the two outer rails. The two outer rails 5 and 6 were produced as a semi-finished product by extrusion from aluminum or an aluminum alloy and then cut to the required length. In the example, the resulting aluminum profiles of the outer rails 5 and 6 have an identical length L1. The middle rail 7 is shorter than the outer rails. All the rail elements are provided with sliding surfaces.

The lower outer rail 5 and the upper outer rail 6 are provided with a C-shaped basic cross-section, which, in the example of the lower outer rail 5, has a plate-shaped base flange 8, wherein side bars 9 and 10 arranged orthogonally to the base flange 8 are provided on opposing longitudinal sides. The upper outer rail 6 has a base flange 11 and side bars 12 and 13.

The “C shape” of the lower outer rail 5 and the “C shape” of the upper outer rail 6 are arranged with their open sides facing. The base flanges 8 and 11 face away from one another. An interspace 14 is formed between the lower outer rail 5 and the upper outer rail 6, or rather between the lower base flange 8 and the upper base flange 11. The middle rail 7 is arranged in the interspace 14. In the collapsed state of the telescopic system 1, the middle rail 7 is received in largely protected manner.

The middle rail 7 comprises a core element 15, which was likewise produced as a semi-finished produced by extrusion from aluminum or an aluminum alloy and then cut to the required length. In contrast to the outer rails 5 and 6, the resultant aluminum profile of the core element 15 of the middle rail 7 is provided with a cladding material 16. In the present example, the “cladding material” 16 is arranged over the entire surface of the core element 15, specifically as a coating 17, as is indicated by way of the dotted representation thereof. The coating 17 consists in the present example of a sliding material applied as a powder coating. The layer thickness of the finished coating 17 amounts to from 50 μm to 100 μm. The coating 17 is suitable, in particular, for forming the sliding surfaces of the middle rail 7.

The spatial/physical configuration of the middle rail 7 includes, alongside its elongate shape, an H-shaped cross-section 18, with parallel side elements 19 and 20 and a central bar 21 connecting these. The cross-section of the telescopic system 1 as a whole, including the cross-section of the middle rail 7, is most readily visible in FIG. 4 and is described on the basis of this figure. The respective ends of side elements 19 and 20 are in each case adjoined by a sliding bar 22, 23, 24 and 25, which is arranged distally. All the sliding bars are arranged parallel to the central bar 21, with the two sliding bars 22 and 23 being located below the middle bar and forming a lower sliding bar pair. The other two sliding bars 24 and 25 are located above the middle bar 21 and form an upper sliding bar pair.

Being substantially H-shaped, the cross-section of the middle rail 7 forms an opening 26 on an upper side and likewise an opening 27 on a lower side, these openings each forming a guide channel 28 and 29 respectively, i.e., the middle rail 7 comprises a lower guide channel 28 and an upper guide channel 29.

Furthermore, it is apparent from FIG. 1 that the middle rail 7 is provided with stop bars 30 and 31, which are arranged on the side elements 19 and 20. An upper stop bar 30 extends in the longitudinal direction from one end 32 of the middle rail 7 over a portion of the length A1 of the length M1 of the middle rail 7 and forms stop edges 30a and 30b at its ends. The stop edge 30a delimits or defines the maximally extended state. The stop edge 30b delimits or defines the collapsed state of the middle rail 7 relative to the upper outer rail 6. The lower stop bar 31 extends in the longitudinal direction from the opposing end 33 of the middle rail 7 over a part of its length M1 and likewise forms a stop edge at each of its ends, with only the stop edge 31b that delimits or defines the collapsed state of the middle rail 7 relative to the lower outer rail 5 being visible.

In the assembled state, the upper stop bar 30 interacts with a stop groove element 34 of the upper outer rail 6, or with end stop elements 34a and 34b, which are applied in the stop groove element 34 of the upper outer rail 6 at the two ends 36 or 37 respectively. In the present example, a set screw is provided in each case as the end stop element 34a/34b. So that the set screw can be simply applied, the stop groove element 34 is embodied with a width (breadth) which corresponds roughly to the minor diameter of an internal thread for the set screw. In this way, the respective set screw can be screwed in directly, without an internal thread having to be previously cut in the groove walls of the stop groove element 34. A damping element 35a or 35b is respectively associated with each set screw, such that the stop edges 30a/30b of the upper stop bar 30 of the middle rail 7 come into indirect contact with the set screw and into direct contact only with the damping elements 35a/35b. In this way, the two end positions for the displacement of these two rail elements 2 and 3 are defined.

With regard to interplay between the middle rail 7 and the lower outer rail 5, the same principle applies to provision of the above-mentioned lower stop bar 13 on the middle rail 7. In correspondence therewith, the lower outer rail 5 has a stop groove element 38, wherein set screws 41a and 41b are likewise screwed in as end stop elements at ends 39 and 40 of the lower outer rail 5, each with an associated damping element 42 and 42b.

The lower outer rail is provided with three fastening openings 43, 44 and 45, for example for attaching the telescopic system 1 stationarily on a mounting base. Likewise, the upper outer rail 6 is provided with three fastening openings 46, 47 and 48, to which for example an item of industrial plant may be attached which is intended to be displaceable or to which a storage facility may be attached which is intended to be displaceably arranged, e.g., a drawer.

FIG. 2 shows the telescopic system 1 composed of the component parts according to FIG. 1, specifically in a fully retracted state, i.e., all the rail elements (2, 3, 4) have been collapsed into one another. In this representation, only the lower outer rail 5 and the upper outer rail 6 are visible, located congruently one above the other. The middle rail is shorter than the outer rails 5 and 6 and is so far back at the end 49 when the telescopic system 1 is in the retracted state that it is not visible in the perspective view shown.

FIG. 3 shows the telescopic system 1 according to FIG. 2 in the maximally extended state. In the present example, the extended telescopic system 1 is twice as long as it is in the retracted state in FIG. 2. The telescopic system 1 in this exemplary embodiment retains at least the good sliding characteristics of the plastics middle rail known from prior art document DE 20 2005 005 760 U1 . In contrast with this prior art, in the maximally extended state, however, a considerably higher load rating and load-carrying capacity are provided, because the middle rail 7 proposed here comprises a core element 8 which is made from an extruded aluminum semi-finished product which has a greater tensile and flexural strength and a higher modulus of elasticity than the known plastics middle rail. Furthermore, the slidability of the middle rail 7 according to the invention relative to the known plastics middle rail may even be increased. To this end, a coating 17 is applied as cladding material 16, which coating has better sliding material properties than the known plastics middle rail.

FIG. 4 shows a view, as already mentioned, onto the end face 49 of the telescopic system 1 in the direction indicated as IV in FIG. 2. The figure shows the three rail elements 2, 3 and 4, namely the C-shaped lower outer rail 5, the C-shaped upper outer rail 6 and the middle rail 7.

In FIG. 4, the two C-shaped outer rails are directed with the open sides of the C-shaped cross-section/profile toward one another. The base flanges 8 and 9 face away from one another. In this way, the interspace 14 provided for the middle rail 7 is formed between the outer rails 5 and 6 or between the lower base flange 8 and the upper base flange 11. All three rail elements 2, 3, and 4 comprise an extruded aluminum profile. The aluminum profile of the middle rail 7 forms the core element 15 thereof, which is the only one to be provided with a cladding material 16 in the form of a coating 17 of a sliding material. The aluminum profiles of the lower outer rail 5 and the upper outer rail 6, on the other hand, have undergone a surface treatment involving anodization to produce a protective layer for the aluminum. The resultant protective layer can dispense with the application of a material such as in the case of coating 17.

The middle rail 7 comprises an H-shaped cross-section 50 comprising the side elements 19 and 20, which are parallel to one another, and the connecting central bar 21, which is arranged orthogonally to the side elements 19 and 20. At its upper side, the H-shaped cross-section 50 is open and forms the upper guide channel 29. The H-shaped cross-section 50 is likewise open at its lower side and forms the lower guide channel 28. The parallel side elements 19 and 20 of the H-shaped cross-section 50 are adjoined at the ends of the parallel side elements 19 and 20 in each case by one of the sliding bars 22, 23, 24, 25 of the middle rail 7. At the top, the sliding bars 24 and 25 are arranged distally in pairs and parallel to the stated central bar 21. Likewise, the sliding bars 22 and 23 are arranged distally in pairs and parallel to the stated central bar 21.

The lower outer rail 5 has lower guide grooves 51 and 52 which are arranged symmetrically and designed to interact with the lower pair of sliding bars 22 and 23. Likewise, the upper outer rail 6 has upper guide grooves 53 and 54, which are also arranged symmetrically and designed to interact with the upper sliding bar pair 24 and 25.

The lower guide channels 51 and 52 of the middle rail 7 have sliding surfaces 51a/51b and 52a/52b respectively which are arranged facing one another and in parallel. Likewise, the upper guide channels 53 and 54 of the middle rail 7 have guide surfaces 53a/53b and 54a/54b respectively which are arranged facing one another and in parallel.

The sliding surfaces 51a and 52a are located on the base flange 8 of the lower outer rail 5. For the sliding surface 51b, on the other hand, a guide bar 55 is formed which is arranged (proximally) on the inside of the side bar 9 of the lower outer rail 5. In the present example, the guide bar 55 is an integral component of the stop groove element 38, or rather of the lower groove wall 38a of the stop groove element 38. For the sliding surface 52b, a guide bar 56 is formed which is arranged (proximally) on the inside of the side bar 10 of the lower outer rail 5.

The sliding surfaces 53a and 54a are located on the base flange 11 of the upper outer rail 6. For the sliding surface 54b, on the other hand, a guide bar 57 is formed, which is arranged (proximally) on the inside of the side bar 12 of the upper outer rail 6. In the present example, the guide bar 57 is an integral component of the stop groove element 34, or rather of the upper groove wall 34a of the stop groove element 34. For the sliding surface 53b, a guide bar 58 is formed which is arranged (proximally) on the inside of the side bar 13 of the upper outer rail 6.

The sliding bars 22 and 23 of the middle rail 7 each have a bar side 22a or 23a respectively which faces the base flange 8 of the lower outer rail 5. As the example of the sliding bar 22 shows, only part of the bar side 22a comes into contact with the sliding surface 51a of the base flange 8 of the lower outer rail, while another part of this bar side 22a is recessed and is spaced from the sliding surface 51a of the base flange 8. The part of the bar side 22a which comes into contact with the sliding surface 51a forms a sliding surface 22b of the middle rail 7. In the present example, the sliding surface 22b is arranged distally, while the recessed part of the bar side 22a is arranged proximally. An opposing bar side 22c of the sliding bar 22 interacts with that of the guide bar 55, which is an integral component of stop groove element 38. Bar side 22c dispenses with a recessed part. In the position shown in FIG. 4, the bar side 22c does not come into contact with the guide bar 55 of guide groove 51. Instead, a gap 59 is provided. The gap 59 promotes displaceability of the middle rail 7 relative to the lower outer rail 5. A free distal end of the sliding bar 22d ends before a groove base 51c of the guide groove 51; here a void 60 is provided. The configuration of the sliding bar 25 in relation to the guide groove 54 of the upper outer rail 6 corresponds to the configuration of the sliding bar 22 and its associated guide groove 51 of the lower outer rail 5. The configuration of the sliding bar 24 in relation to the guide groove 53 of the upper outer rail 6 corresponds to the configuration of the sliding bar 23 and its associated guide groove 52 of the lower outer rail 5.

Furthermore, two parallel guide ribs 61 and 62 are provided on the base flange 8 of the lower outer rail 5. The guide ribs 61 and 62 are arranged within the C-shaped cross-section of the lower outer rail 5 and oriented orthogonally to the base flange 8.

A lateral guide surface 61b which acts as a sliding surface is provided on a rib outer side 61a of the guide rib 61. Likewise, the guide rib 62 has a lateral guide surface 62b acting as a sliding surface on a rib outer side 62a. The two guide ribs 61/62 form a guide rib pair and the outer lateral guide surfaces 61b and 62b form a sliding surface pair. The lateral guide surfaces 61b and 62b are in contact with the lower guide channel 28 of the middle rail 7, or rather with mutually opposing guide surfaces 28a and 28b of the lower guide channel 28. Said guide surfaces 28a/28b act as sliding surfaces of the middle rail 7 and are provided with the coating 17 of sliding material.

The upper guide channel 29 of the middle rail 7 comprises mutually opposing guide surfaces 29a and 29b. The guide surfaces 29a and 29b likewise serve as sliding surfaces and interact with a pair of parallel guide ribs 63 and 64 which are arranged on the upper outer rail 6. The guide ribs 63 and 64 are arranged within the C-shaped cross-section of the upper outer rail 6 and oriented orthogonally to the base flange 11. The two guide ribs 63/64 form a guide rib pair and the outer lateral guide surfaces 63b and 64b form a sliding surface pair. The lateral guide surfaces 63b and 64b are in contact with mutually opposing guide surfaces 29a and 29b of the upper guide channel 29. Said guide surfaces 29a/29b act as sliding surfaces of the middle rail 7 and are provided with the coating 17 of sliding material.

The middle rail has the two stop bars 30 and 31. The stop bar 31 projects into the stop groove element 38 provided on the lower outer rail 5. There is no contact between the stop groove element 38 and the stop bar 31, meaning that the stop bar 31 can be displaced relative to the stop groove element 38.

Likewise, the other stop bar 30 projects into the associated stop groove element 34 of the upper outer rail 6 without coming into contact with it. The two ends of each stop groove element 34/38 are closed in each case with a set screw (not shown). In this way, the respective stop bar 30 or 31 is displaceable only in a region located between the two set screws. The two set screws therefore act as end stops and delimit the displacement path of the middle rail 7 in both directions of displacement. The set screws have been omitted from the depiction in FIG. 4 for the sake of simplicity.

FIG. 5 shows component parts of a second exemplary embodiment of the telescopic system 1 according to the invention, again as an exploded drawing. The example of FIG. 5 is based on the exemplary embodiment of FIG. 1, to which reference is made in its entirety. The embodiment of FIG. 1 is here supplemented with identical preloading elements 65, 66, 67 and 68. Two preloading elements 65 and 66 are associated with the lower outer rail 5 and two preloading elements 67 and 68 with the upper outer rail 6 and, in the assembled state, are connected non-displaceably with the lower outer rail 5 or the upper outer rail 6 respectively. The purpose of preloading elements 65, 66, 67 and 68 is to improve sliding guidance between sliding surfaces of the respective outer rail 5, 6 and sliding surfaces of the middle rail 7. They preferably also contribute to noise reduction during displacement of the participating rail elements.

With reference to the example of preloading element 67, a retaining element is visible which is configured as a cylindrical retaining projection 69. The retaining projection 69 interacts with a retaining opening, simply in the form of a hole 70, provided in the base flange 11 of the upper outer rail 6. In the present example, the hole 70 has a somewhat smaller diameter than the cylindrical retaining projection 69 which is insertable by press-fit into the hole 70, so resulting in a press-fit connection. Furthermore, a centering head Z having two mutually facing spring elements 67a and 67b is visible on the preloading element 67. The spring element 67a is provided with a sliding surface, namely a spring element sliding surface 67c. The spring element 67b is provided with a sliding surface, namely a spring element sliding surface 67d. In the assembled state, the spring element sliding surfaces 67c and 67d project in part beyond the guide ribs 63 and 64, jutting out sideways in the direction of the side bars 12 and 13 of the upper outer rail 6. In the assembled state, the spring elements are permanently preloaded and their spring element sliding surfaces are in contact with the guide channel 29, or rather in contact with the guide surfaces 29a and 29b thereof, as can be most clearly seen in FIG. 7.

FIG. 6a shows the preloading element 67 on an enlarged scale in a neutral state with its spring elements relaxed. It has a fastening block B and the above-mentioned centering head Z which comprises the spring element sliding surfaces 67c and 67d. The fastening block B has parallel side faces 67e and 67f which fit exactly or with little play S1 between the guide ribs 63 and 64. The space between the guide ribs 63 and 64 forms a receiving groove P1 for the preloading element 67, or rather for the fastening block B thereof. The centering head Z interacts advantageously with the middle rail 7 in such a manner as to center the middle rail 7 relative to the upper outer rail 6. The mutually opposing spring elements 67a and 67b take the form of leaf springs. Their spring element sliding surfaces are in each case outwardly curved. In the present example, both ends of the leaf spring are fixedly connected with the centering head Z, specifically being embodied in one piece with the centering head Z. For the purpose of deflection, the curvature of the spring element 67a/67b firmly clamped/connected at both ends can be changed, i.e., the curvature can flatten out through elastic deformation. The elastic deformation stores spring energy and ultimately brings about the centering effect.

Permanent preloading of the spring elements 67a and 67b of the preloading element 67 provides good centering between the middle rail 7 and the upper outer rail 6.

The preloading element 67 improves sliding guidance. Displacement of the middle rail 7 relative to the upper outer rail 6 is considerably quieter if the preloading element 67 is applied. The noise-reducing effect is particularly good if a second identical preloading element 68 is applied at a given distance D1 from the preloading element 67, for which reason a second hole 71 is provided at distance D1 from the hole 70. Distance D1 corresponds to roughly half the length M1 of the middle rail 7, or the distance D1 is somewhat smaller than half the length M1 of the middle rail 7.

The spring element sliding surfaces 67c and 67d interact with associated guide surfaces 29a and 29b of the upper outer rail 6. In the neutral state of the spring elements 67a and 67b, the distance between the spring element sliding surfaces 67c/67d is greater than the distance between the lateral guide surfaces 63b and 64b of the guide ribs 63 and 64 of the upper outer rail 6.

FIG. 6b shows a perspective view of the preloading element 65, as indicated with VI-b in FIG. 5. The preloading element 65 is identical to the preloading element 67. FIG. 6b affords a view of the centering head Z. The figures show that the centering head Z is configured in one piece with the fastening block B. The one-piece shape is open on the side of the centering head Z. On the inside, a longitudinal rib 73 and a transverse rib 74 cross to form a rib intersection 72, stiffening four side faces of the fastening block, including side faces 65e and 65f. On the inside, four pocket-like cavities 75, 76, 77 and 78 are formed.

FIG. 7 is a view onto an end face of the second exemplary embodiment of the telescopic system 1 with the rail elements 2, 3, and 4. The representation is based on the corresponding view (FIG. 4) of the first exemplary embodiment, to which reference is made in its entirety. The middle rail 7 comprises the core element 15 and the cladding material 16. The cladding material 16 is embodied as a coating 17 of a sliding material.

FIG. 7 merely shows FIG. 4 with the addition of identical preloading elements, with preloading element 65 and preloading element 67 being visible. The preloading element 67 is connected with the upper outer rail 6. To this end, it is inserted between the guide ribs 63 and 64. To connect the preloading element 67 with the upper outer rail 6, the cylindrical retaining projection 69 is inserted by press-fit into the hole 70 provided in the base flange 11 of the upper outer rail 6.

The preloading element 65 is connected with the lower outer rail 5 and inserted to this end between the guide ribs 61 and 62 thereof. To achieve a non-displaceable connection with the lower outer rail 5, the preloading element 65 likewise has a cylindrical retaining projection 79 inserted by press-fit into a hole 80 of the base flange 8 of the lower outer rail 5. The preloading element 65 has the centering head Z, which is provided with spring elements 65a and 65b. The spring element 65a projects beyond the guide rib 61 and juts sideways toward the side bar 9, wherein it is in contact with the guide surface 29a of the guide channel 29 of the middle rail 7. Likewise, the spring element 65b projects upward beyond the guide rib 62. Moreover, the spring element 65b, or rather its spring element sliding surface 65c, juts sideways toward the side bar 10 and is in contact with the guide surface 28b of the guide channel 28 of the middle rail 7. A gap S2 is provided between the centering head Z and the base of the guide channel 28. When assembled in this way, the spring elements 65a and 65b are permanently preloaded. Permanent preloading promotes centering of the middle rail 7 relative to the lower outer rail 5.

A gap is likewise provided between the centering head Z of the preloading element 67 and the base of the guide channel 29.

FIG. 8 shows the second exemplary embodiment of the telescopic system 1 assembled and in the extended state. The representation is based on FIG. 3, which shows the first exemplary embodiment in the extended state; to which reference is in its entirety. The drawing of FIG. 8 differs solely in that it shows the preloading element 65, which is connected with the lower outer rail as illustrated and explained on the basis of FIG. 7.

A third exemplary embodiment of a telescopic system according to the invention is shown in FIGS. 9 and 10. FIG. 9 shows the component parts of the third exemplary embodiment in the form of an exploded drawing, specifically again rail elements 2, 3 and 4. The representation shown in FIG. 9 is based on the representation of the second exemplary embodiment according to FIG. 5, to which reference is made here. The exemplary embodiment of FIG. 9 differs, however, in a different middle rail 81. The lower outer rail 5 and the upper outer rail 6 are identical to those of FIG. 5. The different middle rail constitutes a different technical solution from the first two exemplary embodiments. The essential difference displayed by this middle rail 81 is that it consists of a metal or a metal alloy. It is made, for example, from an extruded aluminum semi-finished product. The surface of the middle rail 81 dispenses with a coating having a cladding material intended to improve sliding properties. Preferably, no coating is provided at all. Instead, in the case of aluminum, the surface is embodied as an untreated aluminum surface or preferably as an anodized aluminum surface. The metal or metal alloy used exhibits a high tensile and flexural strength and a high modulus of elasticity.

FIG. 9 comprises identical preloading elements 65, 66, 67 and 68, of which two preloading elements 67 and 68 are inserted by press-fit into holes 70 and 71 respectively in the upper outer rail 6 and two preloading elements 65 and 66 into corresponding holes in the lower outer rail 6. When assembled in this way, preloading elements 65, 66, 67 and 68 are connected non-displaceably with the respective outer rail 5 or 6 respectively. They enhance sliding guidance between the sliding surfaces of the respective outer rails (5, 6) and the sliding surfaces of the middle rail 81. This measure preferably brings about a significant reduction in noise during displacement.

A view onto the end face of the telescopic system of the third exemplary embodiment is here dispensed with because reference can be made to the representation of FIG. 7.

The only difference is that the middle rail 81 does not have any cladding material, indicated in FIG. 7 as a dotted surface.

Furthermore, when assembled, preloading elements 65, 66, 67 and 68 exhibit permanent preloading of their spring elements and in this way provide good centering between the middle rail 81 and the upper outer rail 6 on the one hand and between the middle rail 81 and the lower outer rail 6 on the other hand.

FIG. 10 shows the telescopic system 1 of FIG. 9 in the assembled state, with the rail elements 2, 3 and 4 fully retracted.

### LIST OF REFERENCE NUMERALS

1 Telescopic system
2 Rail element
3 Rail element
4 Rail element
5 Lower outer rail
6 Upper outer rail
7 Middle rail
8 Base flange (lower)
9 Side bar
10 Side bar
11 Base flange (upper)
12 Side bar
13 Side bar
14 Interspace
15 Core element
16 Cladding material
17 Coating
18 Cross-section
19 Side element
20 Side element
21 Central bar
22 Sliding bar
22b Sliding surface
22c Bar side
23 Sliding bar
24 Sliding bar
25 Sliding bar
26 Opening
27 Opening
28 Lower guide channel
28a Guide surface
28b Guide surface
29 Upper guide channel
29a Guide surface
29b Guide surface
30 Upper stop bar
30a Stop edge
30b Stop edge
30c Stop edge
31 Lower stop bar
31a Stop edge
31b Stop edge
32 End
33 End
34 Stop groove
34a End stop element
34b End stop element
35a Damping element
35b Damping element
36 End
37 End face
38 Stop element (lower)
39 Ends
40 Ends
41a Set screw
41b Set screw
42a Damping element
42b Damping element
43 Fastening opening (lower)
44 Fastening opening
45 Fastening opening
46 Fastening opening
47 Fastening opening
48 Fastening opening
49 End (telescopic system)
50 H-shaped cross-section
51 Lower guide groove
51a Sliding surface
51b Sliding surface
52 Lower guide groove
52a Sliding surface
52b Sliding surface
53 Upper guide groove
53a Sliding surface
53b Sliding surface
54 Upper guide groove
54a Sliding surface
54b Sliding surface
55 Guide bar
56 Guide bar
57 Guide bar
58 Guide bar
59 Gap
60 Void
61 Guide rib
61a Rib outer side
61b Lateral guide surface
61b Lateral guide surface
62 Guide rib
62b Lateral guide surface
63 Guide rib
63a Rib outer surface
63b Lateral guide surface
64 Guide rib
64a Rib outer surface
64b Lateral guide surface
65 Preloading element
65a Spring element
65b Spring element
65c Spring element sliding surface
65e Side face
65f Side face
66 Preloading element
67 Preloading element
67a Spring element
67b Spring element
67c Spring element sliding surface
67d Spring element sliding surface
67e Side face
67f Side face
68 Preloading element
69 Cylindrical retaining projection
70 Hole
71 Hole
72 Rib intersection
73 Longitudinal rib
74 Transverse rib
75 Pocket-shaped cavity
76 Pocket-shaped cavity
77 Pocket-shaped cavity
79 Pocket-shaped cavity
80 Hole
81 Middle rail
A1 Portion of the length
B Fastening block
D1 Distance
L1 Length
M1 Length
S1 Play
S2 Gap
P1 Receiving groove
X Longitudinal direction
Z Centering head

1. A telescopic system (1) with rail elements (2, 3, 4), which are displaceable relative to one another in the longitudinal direction (X), at least one rail element forming a lower outer rail (5) and at least one rail element forming an upper outer rail (6), with the proviso that at least one further rail element forms a middle rail (7, 81) arranged between the lower outer rail (5) and the upper outer rail (6), all the rail elements having sliding surfaces (51a, 51b, 52a, 52b, 53a, 53b, 54a, 54b), wherein at least the middle rail (7) has a core element (15) and a cladding material (16), and in that the cladding material (16) at least in places forms the sliding surfaces of the middle rail (7).

2. The telescopic system (1) according to claim 1, wherein at least one of the rail elements (2, 3, 4) comprises an aluminum alloy.

3. The telescopic system (1) according to claim 1, wherein the cladding material (16) is applied to the core element (15) as a coating (17) of a sliding material or a plain bearing plastics material, and/or
wherein the sliding material is a plain bearing plastics material belonging to the class of tribologically optimized plain bearing plastics materials, and/or
wherein the coating (17) of cladding material (16) arranged on the core element (15) of the middle rail (7) has a layer thickness in the range from 50 μm to 500 μm.

4. (canceled)

5. (canceled)

6. The telescopic system (1) according to claim 1, wherein at least one of the outer rails (5, 6) is made from an aluminum alloy and an anodized aluminum layer is provided on the surface thereof.

7. The telescopic system (1) according to claim 1, wherein the lower outer rail (5) has at least one lower guide groove (51, 52) and the middle rail (7, 81) has at least one associated complementary lower sliding bar (22, 23), and/or
wherein the upper outer rail (6) has at least one upper guide groove (53, 54) and the middle rail (7, 81) has at least one associated complementary upper sliding bar (24, 25), and/or
wherein the lower outer rail (5) and/or the upper outer rail (6) is/are provided with a C-shaped basic cross-section, wherein the C-shaped basic cross-section has a plate-shaped base flange (8, 11), and wherein side bars (9, 10, 12, 13) arranged orthogonally to the base flange (8, 11) are provided on opposing longitudinal sides of the base flange (8, 11), and/or
wherein the C-shaped base cross-section is supplemented on at least one of the side bars (9, 10, 12, 13) with a proximally arranged guide bar (55, 56), such that a guide groove (51, 52, 53, 54) is formed between the guide bar (55, 56) and the base flange (8, 11).

8. (canceled)

9. (canceled)

10. (canceled)

11. The telescopic system (1) according to claim 7, wherein at least one guide rib (61, 62, 63, 64) is arranged in the longitudinal direction (X) of the upper outer rail (6) and/or in the longitudinal direction (X) of the lower outer rail (5) on the respective base flange (8, 11) thereof, and/or
wherein the guide ribs (61/62) are arranged in parallel and in pairs or the guide ribs (63/64) of the base flange (8, 11) form distally arranged lateral guide surfaces (61b, 62b, 63b, 64b), and/or
wherein a receiving groove (P1) is formed between the guide ribs (61/62) arranged in parallel and in pairs or the guide ribs (63/64) of the base flange (8, 11).

12. (canceled)

13. (canceled)

14. The telescopic system according to claim 11, wherein at least one preloading element (65, 66, 67, 68) is arranged non-displaceably on the lower outer rail (5) and/or on the upper outer rail (6), and/or
wherein the preloading element (65, 66, 67, 68) has a fastening block (B) and a centering head (Z), and/or
wherein the fastening block (B) is arranged non-displaceably in the receiving groove (P1) of the lower outer rail (5) or upper outer rail (6).

15. (canceled)

16. (canceled)

17. The telescopic system (1) according to claim 7, wherein the centering head (Z) of the preloading element (65, 66, 67, 68) projects beyond the free ends of the parallel guide ribs (61, 62, 63, 64), and wherein spring elements (67a, 67b) with spring element sliding surfaces (65c, 67c, 67d) are provided opposite one another on the centering head (Z) and which, in the assembled state, point in the direction of the side bars (9, 10, 12, 13) of the respective outer rail (5, 6).

18. The telescopic system (1) according to claim 7, wherein the middle rail (7, 81) comprises lower sliding bars (22, 23) arranged in pairs, these being arranged distally such that, in the assembled state, they point in the direction of the side bars (9, 10) of the lower outer rail (5), and wherein the middle rail (7, 81) comprises upper sliding bars (24, 25) arranged in pairs, these being arranged distally such that, in the assembled state, they point in the direction of the side bars (12, 13) of the upper outer rail (6).

19. The telescopic system (1) according to claim 18, wherein the middle rail (7, 81) is conveniently provided between the lower pair of sliding bars (22, 23) with a lower guide channel (28), in that the cross-section of the lower guide channel (28) has an opening (27) which, in the assembled state, is directed toward the base flange (8) of the lower outer rail (5), in that the middle rail (7, 81) is conveniently provided between the upper pair of sliding bars (24, 25) with an upper guide channel (29), and wherein the cross-section of the upper guide channel (29) has an opening (26) which, in the assembled state, is directed toward the base flange (11) of the upper outer rail (6).

20. The telescopic system (1) according to claim 19, wherein the lower guide channel (28) and the upper guide channel (29) of the middle rail (7, 81) are provided with internal guide surfaces (28a, 28b, 29a, 29b) facing one another in pairs and wherein, in the assembled state, the respective internal guide surfaces (29a, 29b) interact respectively with the lower outer rail (5) or with the upper outer rail (6), namely with the lateral guide surfaces (61b, 62b, 63b, 64b) of the parallel guide ribs (61, 62, 63, 64) which the base flange (8) of the lower outer rail (5) or the base flange (11) of the upper outer rail (6) respectively comprises and, on the other hand, in the assembled state the respective internal guide surfaces (28a, 28b, 29a, 29b) interact with the assembled preloading element (65, 66, 67, 68), namely with the mutually facing spring element sliding surfaces (65c, 67c, 67d) of the centering head (Z) of the respective preloading element.

21. The telescopic system (1) according to claim 14, wherein the preloading element (65, 66, 67, 68) is made of plastics material.

22. The telescopic system (1) according to claim 1, wherein the lower outer rail (5) and the upper outer rail (6) are each provided with a stop groove element (34, 38), and in that the middle rail comprises a lower stop bar (31) which, in the assembled state, projects into the stop groove element (38) of the lower outer rail (5), and comprises an upper stop bar which, in the assembled state, projects into the stop groove element (34) of the upper outer rail (6).

23. The telescopic system (1) according to claim 22, wherein the stop groove element (38) of the lower outer rail (5) and the stop groove element (34) of the upper outer rail (6) are in each case provided at one end with an end stop element 34b).

24. The telescopic system (1) according to claim 23, wherein the end stop element takes the form of a set screw (41a, 41b) screwed into the respective stop groove element (34, 38).

25. The telescopic system (1) according to claim 23, wherein the lower stop bar (31) is recessed in the longitudinal direction (X) from the end (33) of the middle rail (7, 81) over a portion of the length of the middle rail (7, 81) and forms two lower stop edges (31b), and in that the upper stop bar (30) is likewise recessed in the longitudinal direction (X) from the other end (32) of the middle rail (7, 81) over a portion of the length (A1) of the middle rail (7, 81) and forms two upper stop edges (30a, 30b).

26. The telescopic system (1) according to claim 1, further comprising at least one preloading element (65, 66, 67, 68) is arranged non-displaceably on the lower outer rail (5) and/or on the upper outer rail (6).

27. The telescopic system (1) according to claim 26, wherein the preloading element (65, 66, 67, 68) has a fastening block (B) and a centering head (Z).

28. The telescopic system (1) according to claim 27, wherein a retaining element is used to arrange the fastening block (B) non-displaceably in the receiving groove (P1) of the lower outer rail (5) or upper outer rail (6).

29. The telescopic system (1) according to claim 27, wherein the centering head (Z) of the preloading element (65, 66, 67, 68) projects, in the assembled state, beyond the free ends of the parallel guide ribs (61, 62, 63, 64) of the respective outer rail (5, 6), wherein spring elements (65a, 65b, 67a, 67b) with spring element sliding surfaces (65c, 65d, 67c, 67d) are arranged opposite one another on the centering head (Z), and wherein, in the assembled state, the spring elements (65a, 65b, 67a, 67b) jut out with their spring element sliding surfaces (65c, 65d, 67c, 67d) toward the side bars (9, 10, 12, 13) of the respective outer rail (5, 6).

30. (canceled)
